(19) United States
(12) Patent Application Publication
(10) Pub. No.: US 2020/0410473 A1
(43) Pub. Date: Dec. 31, 2020

(54) REGISTRATION OF ELECTRONIC PAYMENT MEANS

(71) Applicant: GIESECKE+DEVRIENT MOBILE SECURITY GMBH, Munchen (DE)

(72) Inventors: Thomas TARANTINO, Laufen (DE); Sascha BEHLENDORF, Ebersberg (DE); Klaus FINKENZELLER, Unterfohring (DE); Michael BALDISCHWEILER, Munchen (DE); Stefan KLUGE, Munchen (DE)

(21) Appl. No.: 16/980,968

(22) PCT Filed: Mar. 11, 2019
(86) PCT No.: PCT/EP2019/000076

§ 371 Date: Sep. 15, 2020

(30) Foreign Application Priority Data
Mar. 15, 2018 (DE) 10 2018 002 122.0

(51) Int. Cl. G06Q 20/32; G06Q 20/10; G06Q 20/40

(52) U.S. Cl. CPC G06Q 20/321; G06Q 20/3278; G06Q 20/4014; G06Q 20/108; G06Q 20/102

(57) ABSTRACT

A method for registering electronic payment means and a registration arrangement which is adapted accordingly. Further, a computer program product is proposed having control commands that implement the proposed method and/or operate the proposed registration arrangement.

The present invention is directed to a method for registering electronic payment means and to a registration arrangement which is adapted accordingly. Further, a computer program product is proposed, with control commands that implement the proposed method and/or operate the proposed registration arrangement.

Typically, users employ several end devices with which they want to effect payments, for example. Here, according to known methods, a registration with a service provider is effected including registration data. Such registration data can include, for example, a public key and a secret key. A public key can be, for example, a user identification, or also a credit card number. In addition, a secret information item is typically deposited, for example a PIN number or also a password. In the case of a payment transaction, according to conventional methods the physical end device is then supplied, and a data exchange is effected in such a manner that the service provider can identify the person's payment and, for example, has access to bank information via an established user account.

According to further known methods, various end devices are known which are intended to fit into such a payment process. Thus, it can be assumed that with the increasing technological development, a user will have several devices with which he wishes to make available uniform account information and/or payment information. There are various new types of mobile end devices in circulation, such as, for example, so-called wearables. A wearable is a piece of clothing or a piece of jewelry, such as, for example, bracelet which the user carries with him and which identifies itself, for example, by means of incorporated electronics. In particular, the person skilled in the art knows so-called fitness bracelets which have a processor, a non-volatile memory and a touch display. It is possible to integrate an interface in such a wearable in such a manner that a user can authenticate himself wirelessly at a payment terminal. Thus, there is a need to make available a particularly secure and comfortable hardware environment that enables the user to incorporate these novel portable computers into existing system architectures.

The problem here is that a user always holds a small number of payment accounts or only one payment account. However, since this user now carries a large number of mobile end devices with him, it is particularly disadvantageous in accordance with the prior art that he potentially also has several identities through these several devices, which he has to manage. Typically, user accounts are manufacturer-specific and do not allow users to carry out cross-platform identification.

Therefore, the user must hold a first account for individual mobile end devices or for mobile end devices from one manufacturer in accordance with known methods and in turn hold a further account for further end devices or for end devices from other manufacturers. This is particularly disadvantageous since the user is prevented from a simple payment process and would therefore typically always pay via the same end device. It is particularly desirable here that there is a possibility that a user can operate several end devices and only has to manage one single account information item. This would make it possible for the user to choose between several end devices which have uniform access to a single account and/or can authorize a payment transaction here.

It is therefore an object of the present invention to make available a method which enables a user to supply several physical payment means, but nevertheless enables payment in a simple and secure manner. It is particularly required that this be effected with little technical effort, taking existing hardware arrangements into account. It is further an object of the present invention to make available a correspondingly adapted registration arrangement together with a computer program product for implementing the proposed method and/or for operating the registration arrangement.

The object is achieved with the features of patent claim 1. Further advantageous embodiments are stated in the subclaims.

Accordingly, a method for registering electronic payment means is proposed. In this case, a transmission of a payment means identification is effected from at least one payment means to a mobile end device. Subsequently a depositing is effected of the one payment means identification at a central authorization facility and an authorizing is effected of a request by the central authorization facility, wherein the request is initiated by at least one payment means which has transmitted a payment means identification. The mobile end device carries out the deposit here.

An electronic payment means is any payment means which, by means of data exchange, enables a payment process to be carried out or merely to be initiated. This can be a credit card, for example, which can be read out by means of an air interface. It is particularly advantageous here that typically each payment means has a unique payment means identification. This can be a credit card number for a credit card, but can also include a serial number for a wearable, for example. Thus, the credit card, which can be read out electronically, or a wearable is an electronic payment means.

The user holds the physical payment means ready for payment and initiates a payment process. Here, the person skilled in the art knows further components which are used according to the invention. For example, a payment terminal is provided with which the user is to pay at a checkout, for example. He now holds any one of his registered payment means to this terminal and thus initiates a payment process.

For this to be effected independently of the payment means operated by the user, it is necessary that the payment means or the several payment means are initially registered in order to allow uniform access to the account information.

For this purpose, in a prepared method step, a payment means identification is transmitted in each case from at least one payment means. If, for example, a user has several credit cards and a so-called wearable, he transmits this to a mobile end device. The user thus transmits several credit card identifications and one identification of the wearable as payment means identification. Here, the user can employ his own mobile end device, for example a smart phone, in a particularly advantageous manner. For this purpose, an application and/or control commands can be made available to the user which allow an air interface to be addressed in such a manner that the payment means identification or the payment means identifications are transmitted to the mobile end device. This process can be carried out iteratively in such a manner that all payment means are known to the mobile end device. The payment means are known by a unique payment means identification in each case. Further, for the transmission and registration of the payment means identification of a payment means, a PIN specific to the payment means can be queried from the user. The PIN can be contained, for example, in a packaging of the payment means.

It is thus also possible to deposit the payment means identifications of the transmitted data with a central authentication facility. This can be effected, for example, in such a manner that the mobile end device, here a smart phone, transmits the collected payment means identifications to the authorization facility by means of mobile communication. After this method step, the central authorization facility knows all payment means identifications with which a user wants to pay. It is particularly advantageous here that all payment means identifications can be assigned to payment means that an individual user operates. It is therefore also possible to recognize that if a specific payment means is to be employed for a payment transaction, said payment means is from a specific user. Thus there is also an assignment effected of several payment means to one user.

Once this has been done, an authorization of a request can be effected by the central authorization facility, wherein the request is initiated by at least one payment means. For example, when a user supplies his payment means at a payment terminal, he initiates a corresponding payment request. Such a payment request is submitted or transmitted to the authorization facility, which can now search through the deposited payment means identifications and recognizes that a specific payment means supplied is to be assigned to a specific user.

In this case, it can be necessary to transmit further data that enable authorization. This can be, for example, secret keys such as, for example, a PIN number or a password. A payment terminal thus transmits the request to the authorization facility and this authorization facility then recognizes which user now wants to pay on the basis of the deposited payment means identifications.

The user is an operator of the electronic payment means here. In general, a user can also be identified by means of a user account. It is therefore particularly advantageous to use the concept of the user account instead of a user. It is therefore possible to assign all payment means employed to one respective user account. In this manner, the term “user” is in no way to be understood as limiting, but rather all payment means are to be assigned to a user account through which payment is to be made. For example, the user registers his credit card or his wearable under his name and creates a user account for this. It is thus particularly advantageous that all payment means can be assigned to a user account by their payment means identification, which has further information, such as, for example, payment information. It is possible to deposit the public and secret keys in the user account, or to make this information available along with transmitting or depositing.

Authorization is only effected for those payment means that have already positively deposited a payment means identification. Here, it is possible, for example, to maintain a list of payment means identifications which offers information about which user and/or which user account which payment means identifications are assigned to. A check is therefore further carried out whether the payment means identification is present and whether it is to be assigned to a user. An authorization of the request is then effected. For example, the request is a payment request that was initiated by a payment means. For example, the user holds a credit card in front of a payment terminal, wherein the credit card has already been registered, i.e. deposited. The authorization facility now looks up which user this credit card is assigned to and subsequently authorizes the payment process. If the user further supplies another payment means, for example at a different terminal, it is also verified whether this other payment means has already been deposited, whereupon in turn an authorization is effected if a payment means identification has been transmitted. If no payment means identification was transmitted, the corresponding payment means has not been registered and thus no authorization is effected.

Further, the user can, for example at the authentication facility, deactivate individual payment means identifications of his payment means via his mobile end device, e.g. a smart phone, without the payment means having to be physically present.

In addition, the properties of the payment means assigned to a user can also be flexibly configured via the central authentication facility. For example, so-called payment limits can be deposited for the respective payment means, a temporally limited use of the payment means can be determined, a release of the payment means can be determined when the payment means is resold, the payment means can be activated and/or deactivated, and a name of the payment means can be designated, a photo of the payment means can be stored and/or restrictions can be defined regarding a location and/or a product group.

According to one aspect of the present invention, the at least one payment means is present in the form of a physical payment means. This has the advantage that a particularly high level of security is guaranteed, since both the mobile end device and the payment means are present as separate devices. This makes it possible to rule out attacks that are purely software-based and imitate a certain payment means. Further, it is therefore more difficult to read out data, since a physical payment means is typically not continuously coupled to a network.

According to a further aspect of the present invention, the at least one payment means is a credit card, a wearable, a token, a key pendant, a sticker and/or a mobile end device. This has the advantage that common payment means can be reemployed according to the proposed method, and in particular that the payment means can be embedded in already existing system architectures. It is therefore not necessary, for example, to create a new credit card for the user, since he can already deposit an existing credit card or many existing credit cards at the authorization facility by means of the mobile end device. For example, it is possible for the user to register a credit card as well as a key pendant, which has corresponding electronic components, with the authorization facility, i.e. the corresponding electronics of the key pendant or of the credit card are read out, transmitted to the mobile end device and deposited from there at the authorization facility. It is thus possible to authorize a payment request both from a credit card and from a key pendant uniformly by the authorization facility in such a manner that they are to be assigned to a single user account. According to the invention, this is effected by authorizing only those payment means or authorizing the request by only those payment means for which a payment means identification has already been transmitted. The user thus has the possibility of depositing all of his payment means by means of the payment means identification with the authorization facility. If a different user now wants to pay with his payment means, no authorization takes place if this payment means identification has not been transmitted. However, if it has been transmitted, this new payment means identification is thus to be assigned to a new user, and it can be debited in targeted manner from the user account for which the respective payment means is approved.

According to a further aspect of the present invention, the authorizing comprises grouping the at least one payment means. This has the advantage that a large number of payment means can be registered and the payment means can be grouped such that a group of payment means is always to be assigned to a user or a user account. In this manner, it can be determined by means of the payment means identification which payment means has been registered for which user, and authorization or debiting is effected only with respect to that user to whom the payment means is effectively assigned.

According to a further aspect of the present invention, the payment means identification respectively transmitted by the mobile end device is to be assigned to the mobile end device. This has the advantage that personalization does not only have to take place with regard to the user account, but rather all payment means identifications which have been transmitted by a specific end device can also be assigned to this specific end device. The user thus authenticates himself by means of his mobile end device, and all payment means which have transmitted their payment means identification to the mobile end device can also be assigned to this mobile end device. For example, a network operator has information relating to the mobile end device, and all payment transactions can be carried out using the payment means which are to be assigned to the mobile end device. For example, it is thus possible for a mobile end device, such as a smart phone, to register several payment means, and thus for the network operator to be able to debit the respective payment requests from the smart phone user's telephone bill. Thus, the user can always identify himself with a multiplicity of payment means, wherein the billing is always effected via his mobile end device.

According to a further aspect of the present invention, the payment means identification respectively transmitted by the mobile end device is to be assigned to exactly one user account. This has the advantage that a unique identification of the payment transactions is possible, wherein a large number of payment means can potentially be used. Thus, according to the invention, it is possible for the user to operate several payment means, but always to have them cause a debiting from one user account.

According to a further aspect of the present invention, the transmission of a payment means identification is carried out in each case via an air interface. This has the advantage that, for example, near-field communication can be carried out between the payment means and the mobile end device. In this manner, the user can deposit his payment means on his smart phone in a simple manner without any technical effort. For example, it is also possible to photograph a credit card and, for example, by means of text recognition, to deposit the corresponding data, such as, for example, a credit card number.

According to a further aspect of the present invention, the payment means identification is transmitted and/or deposited together with a security information item. This has the advantage that further information items can also be made available that serve for authorization. For example, these can be public and secret keys. For example, it is possible to also deposit corresponding security numbers, such as, for example, a PIN or also a password. The user can thus pay with his physical payment means, and an authorization can also be effected employing the authorization data. This means that no further input is required on the side of the user.

According to a further aspect of the present invention, the payment means supplies a set of control commands and requests are authorized that are initiated by a subset of control commands. This has the advantage that, for example, the user can state which applications on the payment means may be authorized and which may not. For example, the payment means, for example a smart card, supplies various applications, and the user can positively describe which applications can participate in a payment process or initiate a payment request. According to known methods, it is thus possible to install a multiplicity of software components on a smart card. According to the invention, these smart cards only have to be adjusted in such a manner that the user determines which of the applications of the smart card may be registered with the authorization facility. These can then participate in the method according to the invention, wherein further untrustworthy applications are not allowed to participate in the authorization.

According to a further aspect of the present invention, a further subset of control commands of at least one payment means are blocked for authorization. This has the advantage that if several applications are deposited on the payment means, it is possible to block also individual applications. The subset of the applications that are allowed to authorize and the subset of those that are not allowed to authorize are disjunct. For example, a user operates a so-called fitness bracelet, which supplies several applications. This is also possible if a so-called smart watch is used. Here, shopping platforms can be enabled in such a manner that they can participate in the method according to the invention, but it is also possible to block applications which are then not authorized. If, for example, a user stores a covered run distance and this application makes a payment request, this is typically an attack on the account information. This application can thus be excluded from authorization. It is further possible for the user to operate a banking application by means of his smart phone or his smart watch, which can then be enabled for authorization.

According to a further aspect of the present invention, a blocking of a payment means is carried out by means of its transmitted payment means identification. This has the advantage that a user can block individual payment means. If, for example, the user stated in previous method steps that a certain credit card should be deposited with the authorization facility and this credit card is lost, the facility can also transmit the payment means identification and thus block the associated credit card. Thus, while it is possible to deposit payment means, it is also possible to remove these payment means from the list again and thus to block the payment means. This is particularly advantageous, since the user can manage his payment means himself.

According to a further aspect of the present invention, a payment means management unit is provided between the authorization facility and the mobile end device. This has the advantage that, for example, a server can be interposed between the smart phone, i.e. the mobile end device, and the authorization facility, which server takes over further processing steps. However, several devices can be managed and the authorization can then be requested from the payment means management unit. The payment means management unit thus serves to receive the payment means identifications.

According to a further aspect of the present invention, the mobile end device communicates with the authorization facility by means of a mobile communication network. This has the advantage that, in addition to other possible components, a mobile communication network can be arranged between the mobile end device and the authorization facility. For example, it is possible for the mobile end device to set up a data connection with a network operator or with components made available by a network operator, and thus to deposit the payment means identifications with the authorization facility via the air interface. A simple method is thus created with which the user can independently deposit his payment means with an authorization facility.

The object is also achieved by a registration arrangement for registering electronic payment means, with a first interface unit adapted for transmitting a respective payment means identification of at least one payment means to a mobile end device. Further, a second interface unit is provided, which is adapted to deposit the respectively one payment means identification with a central authorization facility. The central authorization facility is adapted to authorize a request, wherein the request is initiated by at least one payment means which has transmitted a payment means identification, wherein the mobile end device carries out the depositing.

The object is further achieved by a computer program product with control commands which implement the proposed method and/or which are adapted to operate the proposed registration arrangement.

In the following the invention is described by way of example with reference to the attached figures. The figures are described as follows:

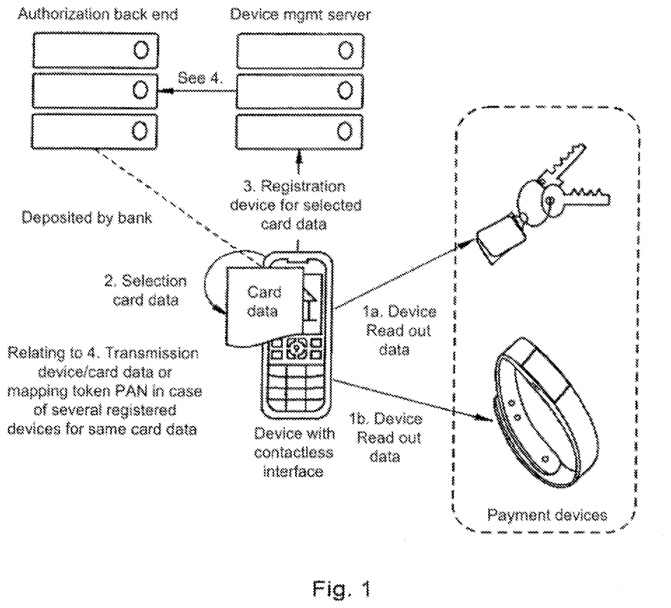

FIG. 1: a registration arrangement according to one aspect of the present invention; and

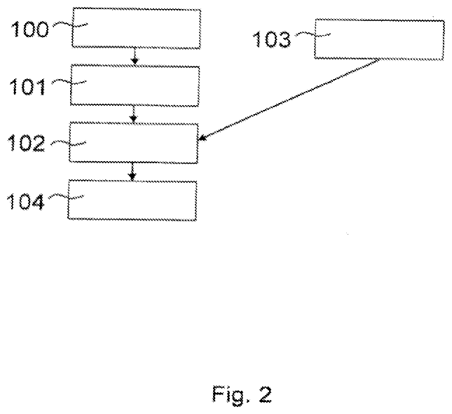

FIG. 2: a method for registration according to an aspect of the present invention.

FIG. 1 shows a registration arrangement in which two payment means are employed. A payment means is, for example, a key pendant that has corresponding communication electronics or also a so-called fitness bracelet. The mobile end device is shown here as a smart phone. An authorization facility is drawn at the top left of FIG. 1, which communicates with a payment means management unit, which is drawn in the middle at the top.

Payment means, e.g. credit cards, are permanently personalized during production or in the field. A secure, user-controlled transfer of his data to other payment means, e.g. wearables, smart phones and the like is not possible. Typically, each payment means has its own data. The invention solves this problem as follows.

The user should be able to log on or log off and use for the respective payment his various payment means at a background server or a background system by means of an application on his smart phone. For logging on, the smart phone reads data from the payment means and sends these to the background system in order to log the payment means on the background system so that the user can execute a payment with the logged-on payment means. Previously logged in payment means are logged off. When logging off, the user can log off any desired payment means from the background system or from the authorization facility by means of his smart phone.

In this manner, the user determines which payment means are active. Further, he can utilize the same data on several payment means. Thus, in particular, an advantageous solution for wearable technology is made available.

It is thus a use scenario of the present invention that a user typically cannot carry out a controlled transmission of his own data, such as, for example, card data, PAN, PIN, applications, keys and the like, to a different end device. For example, a card holder has payment devices in various forms, for example credit cards, a wearable from manufacturer A, a wearable from manufacturer B, mobile end devices or the like and wishes to use them alternately with the same card data. Typically, however, each device has its own card identification, for example its own primary account number, own keys and the like. Thus, the user should be given the opportunity to use his card data flexibly, independently, but in a controlled manner on different payment devices and at the same time to prevent misuse of the data by third parties.

It is particularly advantageous to supply an application which is installed on a device, for example a smart phone. The device mentioned can have a contactless interface, for example NFC, Bluetooth or the like. Further, a central background system or an authorization facility is necessary, which is connected to the respective devices via one of the interfaces mentioned. With this system, the user is to be put in a position to flexibly log on and log off his various payment devices in the background system mentioned and then utilize them for the respective payment process. How this log-on and log-off process looks in detail is described below by way of example.

The user holds the desired payment means to the device, which has a corresponding contactless interface, e.g. NFC, Bluetooth, low-energy or the like, and on which the application for managing the card data or devices is running. A connection to the background system or to the authorization facility between the device with the contactless interface and the system itself must already be established at this time.

Device-specific data can then be read out from the payment end device and transmitted to the background system, e.g. a TAN, card holder name and the like. The read-out data are subsequently transmitted to the background system in order to “log in” or register the respectively present device there. In the case that the payment device is a display card, multi-application card, for example, the user can additionally execute in this registration step which of his applications disposed on the payment end device are to be switched to activated. This information is then stored in the background system or the authorization facility, and the user can now pay with the newly activated payment means. Previously registered payments can be automatically logged off from the system.

Analogously to this, the user can also be given the option of linking several payment means to the same card data, provided that the devices are all physically present. This multiple linking must then be handled accordingly by the background system or by the authorization facility. For example, each payment means can be mapped on the system side via a so-called payment token.

Further, the user can also utilize the method described in such a manner that one or several payment means are logged off again. This can also be effected through the non-physical presence of the payment means with the aid of the application. The selected payment means is then logged off in the background system.

The user is given the option to flexibly control which of his payment methods are active or inactive. Further, he is put in a position to utilize the same card data, also called payment identity, on one or several payment means.

A need for this flexible payment identity or payment end device management or also the payment means management arises, among other things, because the number of so-called wearables is increasing. Thus, the user himself should be in a position to load his card data, for example, to a new t-shirt without having to ask his bank for an over-the-air personalization.

FIG. 2 shows a method for registering electronic payment means, wherein in a first step 100 a transmission is effected of respectively one payment means identification from at least one payment means to a mobile end device. In a subsequent method step 101, a depositing is effected of the respectively one payment means identification with a central authorization facility. In the method step 102, an authorization of a request is effected by the central authorization facility, wherein the request is initiated by at least one payment means which has transmitted a payment means identification. The mobile end device carries out the depositing 101 here. The initiating of the payment request or the request in step 103 can be effected in such a way that this can be effected at any time. For an authorizing 102, however, it is required that the payment means identification is already deposited.

It is further possible to carry out individual steps iteratively. For example, the steps 100 and 101 can be carried out iteratively in such a manner that step by step all the payment means identifications of the available payment means are first transmitted and then deposited. Thus, the transmission itself can also be carried out iteratively, and in a single further method step a depositing 101 of all previously transmitted payment means identifications is effected.

In an optional method step 104, a blocking of payment means is effected. If, for example, a user wishes to log off a payment means because, for example, he has lost his credit card, he can also transmit this to the authorization facility, which then deletes the payment means identification, thereby preventing misuse.

Thus, a secure, yet technically simple, method for securely managing several payment means, each of which is physically present, is proposed.

1.-15. (canceled)

16. A method for registering electronic payment means, with the steps of:
transmitting respectively one payment means identification of at least one payment means to a mobile end device;
depositing the respectively one payment means identification with a central authorization facility; and
authorizing a request by the central authorization facility, wherein the request is initiated by at least one payment means which has transmitted a payment means identification, wherein the mobile end device carries out the depositing.

17. The method according to claim 16, wherein the at least one payment means is present as a physical payment means.

18. The method according to claim 16, wherein the at least one payment means is present in the form of a credit card, a wearable, a token, a key pendant, a sticker and/or a mobile end device.

19. The method according to claim 16, wherein the authorizing comprises a grouping of the at least one payment means.

20. The method according to claim 16, wherein the payment means identification respectively transmitted by the mobile end device is to be assigned to the mobile end device.

21. The method according to claim 16, wherein the payment means identification respectively transmitted by the mobile end device is to be assigned to exactly one user account.

22. The method according to claim 16, wherein the transmitting of respectively one payment means identification is carried out via an air interface.

23. The method according to claim 16, wherein the payment means identification is transmitted and/or deposited together with a security information item.

24. The method according to claim 16, wherein the payment means supplies a set of control commands and requests are authorized which are initiated by a subset of control commands.

25. The method according to claim 16, wherein a further subset of control commands of at least one payment means is blocked for authorization.

26. The method according to claim 16, wherein a blocking of a payment means is effected by means of its transmitted payment means identification.

27. The method according to claim 16, wherein a payment means management unit is provided between the authorization facility and the mobile end device.

28. The method according to claim 16, wherein the mobile end device communicates with the authorization facility by means of a mobile communication network.

29. A registration arrangement for registering electronic payment means, having:
a first interface unit adapted to transmit respectively one payment means identification of at least one payment means to a mobile end device;
a second interface unit adapted to deposit the respectively one payment means identification with a central authorization facility; and
the central authorization facility adapted to authorize a request,
wherein the request is initiated by at least one payment means which has transmitted a payment means identification,
wherein the mobile end device carries out the depositing.

30. A computer program product with control commands that implement the method according to claim 16.
